(19) United States
(12) Patent Application Publication
(10) Pub. No.: US 2006/0068297 A1
(43) Pub. Date: Mar. 30, 2006

(54) Electrolytes for lithium ion batteries

(75) Inventors: Weihua Tan, Shenzhen (CN); Junqing Dong, Shenzhen (CN); Zhaosheng Liu, Shenzhen (CN)

Correspondence Address: EMIL CHANG;LAW OFFICES OF EMIL CHANG, 874 JASMINE DRIVE, SUNNYDALE, CA, 94086, US

(73) Assignee: BYD Company Limited

(21) Appl. No.: 11/225,427

(22) Filed: Sep. 13, 2005

(30) Foreign Application Priority Data
Sep. 24, 2004 (CN) 200410051676.X

(51) Int. Cl. H01M 10/40

(52) U.S. Cl. 429/343; 429/339; 429/200; 429/326; 429/329; 429/330

(57) ABSTRACT

The present invention discloses non-aqueous electrolytes for lithium ion batteries. Said electrolytes comprise of lithium salts and a non-aqueous organic solvent. The non-aqueous organic solvent comprises of compounds having the formate derivative or formamide derivative. The chemical formulas for these compounds are HCOOR₁ and HCONR₂R₃, where R₁, R₂, R₃ are alkyls having 1 to 4 carbon atoms. The weight percentage of the compounds having the formate derivative or formamide derivative is between 5 wt % and 70 wt % of the total weight of the non-aqueous organic solvent. Lithium ion batteries using said electrolytes exhibit improved discharge properties at low temperatures. These batteries are especially suitable for use as power batteries with large capacities.

### CROSS REFERENCE

This application claims priority from a Chinese patent application entitled “Non-Aqueous Electrolytes and Their Lithium Ion Secondary Batteries” filed on Sep. 24, 2004, having a Chinese Application No. 200410051676.X. This Chinese application is incorporated here by reference.

### FIELD OF INVENTION

This invention relates to lithium secondary batteries, and in particular, non-aqueous electrolytes of lithium ion secondary batteries.

### BACKGROUND

In recent years, lithium ion rechargeable batteries have been widely used in portable electronics and communications equipment such as cameras, mobile phones, and laptop computers. With increased research, the properties of these batteries are improving rapidly. Lithium ion rechargeable batteries with a small capacity are generally used at temperatures greater than −10° C. As such, the discharge problems that these batteries exhibit at low temperatures are not as apparent.

However, with the rapid development of electric bicycles and automobiles, lithium ion rechargeable batteries with large capacities have become the preferred choice of energy sources for power equipment, as these batteries have a high discharge voltage, high energy density and long cycle life. The operating temperatures for these equipments are often lower than −10° C. At low temperatures, lithium ion rechargeable batteries with large capacities have significant discharge problems that include a low rate of utilization of the active materials, low specific energy, and poor cycling properties.

The discharge properties of these batteries using non-aqueous electrolyte at low temperatures can be improved, not only by changing the active material of the positive and negative electrodes, but also by changing the composition of the non-aqueous electrolyte. When the ambient temperature is relatively low, the ion conductivity of the electrolyte decreases. In addition, its viscosity increases, causing its electrical conductivity to decrease. As a result, the discharge properties of the battery at low temperatures can deteriorate. Increasing the dielectric constant of the electrolyte and enhancing the conductivity of the solvent with the electrolyte solute ions can improve these discharge properties.

Usually, the non-aqueous electrolytes of lithium ion secondary batteries are comprised of solvents with chain organic esters such as dimethyl carbonate, diethyl carbonate, methyl ethyl carbonate etc., or solvents with ring organic esters such as ethylene carbonate, propylene carbonate, vinylene carbonate, γ-butyrolactone. The solutes in the electrolyte are comprised of lithium salts such as lithium perchlorate, lithium hexaaluminate, lithium hexafluorophosphate, lithium tetrafluoroborate, dissolved in the electrolyte. The concentration of the electrolyte solute is usually at 1 mol/l.

Patent CN1278953A noted that batteries achieve better low temperature characteristics and long term stability when compounds with the S—O bond are added to the organic solvent of the electrolyte. However, when this method is used in the electrolyte for large capacity lithium ion rechargeable power batteries with a discharge capacity that is greater than 10 Ah at normal temperatures, the discharge capacity conservation rate at low temperatures and the cycling properties of the batteries are still poor, such that these batteries are unable to meet the demands of the power equipment.

Due to the limitations of the prior art, it is therefore desirable to have novel non-aqueous electrolytes that can enhance the low temperature discharge properties of large capacity lithium ion rechargeable batteries.

### SUMMARY OF INVENTION

An object of this invention is to provide electrolytes that improve the discharge properties of large capacity lithium ion batteries at low temperatures.

Briefly, the present invention relates to new compositions for non-aqueous electrolyte of lithium ion batteries. Said electrolytes are comprised of lithium salts with a non-aqueous organic solvent. The non-aqueous organic solvent is comprised of compounds having the formate derivative or formamide derivative. The chemical formulas for these compounds are HCOOR₁ and HCONR₂R₃, where R₁, R₂, R₃ are alkyls having 1 to 4 carbon atoms. The amount of said compound having the formate derivative or formamide derivative is between 5 wt % and 70 wt % of the total weight of the non-aqueous organic solvent.

An advantage of this invention is that large capacity lithium ion batteries having electrolytes that are embodiments of this invention have improved discharge properties at low temperatures.

### DETAILED DESCRIPTION OF THE PREFERRED EMBODIMENTS

Embodiments of non-aqueous electrolytes for lithium ion rechargeable batteries of the present invention may be comprised of a lithium salt, an electrolyte solute, and a non-aqueous organic solvent. Said non-aqueous organic solvent is comprised of at least a compound having a formate derivative or a compound having a formamide derivative. In preferred embodiments, the compounds are represented by the following formulas:
HCOOR₁ (1)
HCONR₂R₃; (2)

where R₁, R₂, R₃ are alkyls. Preferably, R₁, R₂, and R₃ are alkyls that have 1 to 4 carbon atoms.

Preferred embodiments of said non-aqueous organic solvent may be comprised of at least one compound containing a formate or formamide selected from the following: methyl formate, isopropyl formate, butyl formate, dimethyl formamide, dipropyl formamide.

This invention adds two groups of compounds to the non-aqueous electrolytes of the lithium ion rechargeable batteries, compounds having formates and compounds having formamide. Electrolyte solutes such as LiPF₆, LiAsF₆, LiClO₄ can easily dissolve in this electrolyte.

In addition, the molecules in these compounds contain oxygen and nitrogen atoms that strongly attract electrons. When the number of attached carbons is low, the electrons associated with the hydrogen of the formate and formamide derivatives are strongly attracted to the carbonyl. This results in the strong polarity of molecules having the formate or the formamide derivative and causes the dielectric constant of the electrolyte to increase.

In addition, when the number of carbon atoms attached to the compounds with the formate derivative and formamide derivative is low, strong hydrogen bonds can be formed between molecules. The viscosity of the solvents formed by this type of molecular structure may decrease. Methyl formate and dimethyl formamide are such examples.

As the number of carbon atoms attached to the compounds with the formate derivative and formamide derivative increases, the polarity of the compounds may decrease gradually and the ability to form hydrogen bonds will also decrease gradually. As a result, the dielectric constant is decreased and the viscosity of molecules is increased. Therefore, the preferred number of carbon atoms in the alkyls contained in the compound represented by formulas (1) and (2) is between 1 and 4.

To form the non-aqueous electrolyte, appropriate quantity of ring acid esters, chain acid esters, or their mixtures should be added to form a mixture of solvents. By doing so, a passivated-film can be formed at the surface of the carbon atoms. In addition, the dielectric constant of the solvent and the dissociation of electrolyte solute can be increased. Also, the viscosity of the electrolyte can be adjusted such that the electrolyte has high conductivity and stability, even at low temperatures, i.e., at temperatures between −10° C. and −40° C.

Therefore, in preferred embodiments, said non-aqueous organic solvent is also comprised of at least one chain acid ester selected from the following: methyl carbonate, dimethyl carbonate, ethyl carbonate, diethyl carbonate, methyl ethyl carbonate, ethyl propyl carbonate, diphenyl carbonate, ethyl acetate, methyl acetate, methyl propionate, ethyl propionate, dimethoxy ethane, diethoxy ethane, chain organic esters with fluorine, chain organic esters with sulfate, and chain organic esters with unsaturated bonds.

In preferred embodiments, said non-aqueous organic solvent also contains at least one ring acid ester selected from the following: ethylene carbonate, propylene carbonate, vinylene carbonate, γ-butyrolactone, sultone, ring organic ester with fluorine, ring organic ester with sulfate, and ring organic ester with unsaturated bond.

The optimal quantity of compounds represented by formulas (1) and (2) in the solvent of the non-aqueous electrolyte is related to the types of ring carbonate and chain carbonate that they are mixed with, the types and quantity of electrolyte solutes, and the types and quantity of additives. Too much of either of the above compounds can cause the reduction of the quantity of active materials of negative electrode and the peeling of the carbon layer. On the other hand, if there were too little of the latter, the objective of increasing the high current conductivity rate cannot be achieved. In preferred embodiments, the weight percent of said compounds having the formate derivative or formamide derivative is between 5 wt % and 70 wt % of the total weight of the non-aqueous organic solvent.

In embodiments, the lithium salt is at least one chemical selected from the following: lithium perchlorate, lithium hexaaluminate, lithium hexafluorophosphate, lithium tetrafluoroborate, lithium halide, lithium fluorocarbon fluoro oxide phosphate, and lithium fluorocarbon sulfonate.

The concentration of electrolyte solute has two opposing effects on the electrolyte solution. When the concentration is increased, the electrolyte solute in the solvent that can contribute to dissociation is also increased. This can result in the increase of the electrical conductivity. However, increasing the concentration can also increase the solvent viscosity and cause the decrease in the moving velocity of lithium ions. This results in the decrease in the electrical conductivity. Therefore, there is an optimal value for the concentration of the electrolyte solute. Under normal temperatures conditions, that is, for temperatures between 10° C. and 30° C., this concentration is typically around 1 mol/l. At low temperatures, the effects are similar. However, when temperature drops, the viscosity of solvents increases greatly and significantly affect the conductivity. Therefore, the concentration of electrolyte solute should be reduced slightly and the optimal concentration should be lower than that at normal temperatures. The specific optimal value for the optimal concentration varies depending on the type and composition of the solvent, and the type of electrolyte solute. For electrolyte using EC/DEC, EC/DMC as solvents, and LiPF₆ as solute, the optimal concentration of electrolyte solute is usually lower than 1 mol/l. However, the concentration also cannot be too low as this will decrease the conductivity of the electrolyte. Taking into consideration that the battery may operate at both the normal and low temperature ranges, in preferred embodiments, the concentration of the electrolyte solute, i.e., the lithium salt in the solvent, is between 0.8 mol/l and 1.0 mol/l.

One method to reduce the reaction between the solvent compounds and the embedded lithium is the addition of ring carbonates. Another effective method is to form a passivated-film on the surface of the carbon atoms that is in contact with the electrolyte. To achieve this effect, additives are added such that, during the initial reaction of the battery, they react with the lithium that are embedded in the negative electrode to form a dense solid protective passivated-film. In some embodiments, CO₂, CO, and N₂O can be used as additives. Using CO₂ as an additive is more effective as the principle composition of the passivated-film formed is LiCO₃. The film is thin and dense and can prevent the continued reaction between the solvent and lithium, as well as the cross diffusion of the solvent molecules. In preferred embodiments, between 0.05 wt % and 1.0 wt % of the total weight of the electrolyte of the additive carbon dioxide gas is added into non-aqueous electrolyte.

To fabricate the lithium ion rechargeable batteries using the electrolyte that are said embodiments of this invention, oxides of transition metal lithium are used as the active material for the positive electrodes. They include one or more material represented by the following formulas: LiₓNi_{1-y}CO_{y}O₂, where 0.9≦x≦1.1, and 0≦y≦1.0; LiₓMn_{2-y}B_{y}O₂ where 0.9≦x≦1.1, and 0≦y≦1.0 and B is a transition metal. Examples of the active materials include LiCoO₂, LiNiCoO₂, and LiMnO₄.

The active materials of the negative electrode of said lithium ion rechargeable batteries are carbon group materials that can embed and detach lithium ions. Preferably, the active materials for the negative electrode to be used with electrolytes that are embodiments of this invention are at least one material selected from the following: natural graphite, artificial graphite, middle phase carbon micro-granule, middle phase carbon fiber.

The electrolyte solutes used in the embodiments are metal lithium salts such as LiPF₆ dissolved in organic solvents. After the batteries are fabricated, the lithium ions from the active material of positive electrodes can pass in and out of the granules of carbon to charge and discharge the battery.

The following embodiments and comparison examples further describe this invention in detail. For each electrolyte that is an embodiment or a comparison example, a battery comprising of said electrolyte is fabricated such that the properties of that battery can be tested and compared with other batteries made from other embodiments and comparison examples.

The positive electrodes of the batteries that use the following embodiments and comparison examples are fabricated by the method comprising of:

mixing 91 wt % of LiCoO₂ powder, 6 wt % of graphite flakes as conducting agent and 3 wt % of PVDF as binding agent;

dispersing the mixture into N-methyl pyrrolidone as solvent to form a paste; and

uniformly coating both sides of a 20 μm belt-shaped aluminum foil of positive electrode current collector with the paste mixture;

drying with heat; and

pressing at a pressure of between 0.5 Mpa and 2 Mpa to obtain the belt-shaped positive electrode slice with thickness of 150 μm and length 2070 mm.

The negative electrodes of the batteries that use the following embodiments and comparison examples are fabricated by the method comprising of:

mixing 90 wt % of artificial graphite and 10 wt % of PTFE as binding agent;

dispersing the mixture into de-ionized water as solvent to form a paste;

uniformly coating both sides of a 15 μm belt-shaped copper foil of negative electrode current collector with the paste mixture;

drying with heat; and

pressing at pressure between 0.5 Mpa and 2 Mpa to obtain the belt-shaped negative electrode slice with thickness of 140 μm and length 2150 mm.

The batteries that use the following embodiments and comparison examples are fabricated and assembled by the method comprising of:

winding and stacking the positive electrode slice, separation membrane, negative electrode slice by layers one by one,

inserting into round angle quadric shell of dimension 18×70×125 mm;

injecting the electrolyte in the following embodiments and comparison examples into the battery to obtain the lithium ion rechargeable battery with the non-aqueous electrolyte of that embodiment or comparison example.

The batteries that are fabricated are tested to obtain their characteristics at normal temperatures and low temperatures. To test each battery at normal temperature, the battery is charged to 4.20V at a temperature 25° C. using 1 C current. The cut-off charging current is 150 mA. The battery is then discharged to 2.75V using 1 C current. The discharging capacity at normal temperatures C_{N} is obtained. Similarly the discharge capacity at low temperature C_{L} is obtained by repeating the above stated procedure at −25° C. That is, at −25° C., the battery is charged using 1 C current of −25° C. to 4.2V. The cut-off charging current is 150 mA. The battery is then discharged to 2.75V using 1 C current. The discharging capacity at low temperatures C_{L} is then obtained. The discharging ratio at low/normal temperatures, k, is defined as k=C_{L}/C_{N}×100%.

### Embodiment 1

The electrolyte in this embodiment is fabricated as follows:

mixing methyl formate, a compound that contains the formate derivative as represented by formula (1); with ethyl carbonate(EC), diethyl carbonate (DEC) in the weight ratio of 5:25:70;

adding the electrolyte solute LiPF₆ with concentration of 0.9 mol/l; and

at the same time, adding CO₂ at 0.2 wt % of total weight of electrolyte.

### Embodiment 2

The composition of the solvent in the electrolyte in this embodiment is changed to methyl formate: EC:DEC=45:15:40. Everything else remains the same as in Embodiment 1.

### Embodiment 3

The composition of the solvent in the electrolyte in this embodiment is changed to methyl formate: isopropyl formate: EC:DEC=60:10:15:15. Everything else remains the same as in Embodiment 1.

### Embodiment 4

The composition of the solvent in the electrolyte of this embodiment is changed to dimethyl formamide: EC:DEC=30:15:55 and the concentration of electrolyte solute is changed to 0.8 mol/l. Everything else remains the same as in Embodiment 1.

### Embodiment 5

The composition of the solvent in the electrolyte in this embodiment is changed to dimethyl formamide: dipropyl formamide: EC:DEC=15:5:40:40 and the concentration of electrolyte solute is changed to 0.7 mol/l. The additive, CO₂, additive is not added. Everything else remains the same as in Embodiment 1.

### Embodiment 6

The composition of the solvent in the electrolyte in this embodiment is changed to methyl formate: butyl formate: dipropyl formamide: EC:DEC=15:10:15:30:30. Everything else remains the same as in Embodiment 1.

### COMPARISON EXAMPLE 1

The electrolyte in this comparison example is fabricated as follows:

mixing ethyl carbonate (EC), diethyl carbonate (DEC) and dimethyl carbonate(DMC) in the weight ratio of 15:15:70;

adding the electrolyte solute LiPF₆ with concentration of 1.0 mol/l; and

not adding the additive CO₂.

Everything else remains the same as in Embodiment 1.

### COMPARISON EXAMPLE 2

The electrolyte in this comparison example is fabricated as follows:

mixing propenoic carbonate (PC), diethyl carbonate (DEC) and dimethyl carbonate(DMC) in the weight ratio of 30:25:45;

adding the electrolyte solute LiPF₆ with concentration of 1.0 mol/l; and

not adding the additive CO₂.

Everything else remains the same as in Embodiment 1.

The results of the testing of the discharge properties of the batteries fabricated using the electrolytes from the above embodiments and comparison examples are shown in Table 1 and Table 2.

Comparing the electrical properties of the batteries fabricated with electrolytes in the above described embodiments and comparison examples shows that, at normal temperatures, there is little difference in the discharge capacities of batteries between electrolytes containing compounds with formate derivative or formamide derivative and traditional electrolytes that do not contain either of these two derivatives. However, at temperatures below −25° C., there is a significant difference in the discharge capacities. In addition, for the solvents containing the same formate derivative or formamide derivative, when different alkyls are attached, the low temperature properties exhibit large differences. Generally speaking, the less the number of carbon atoms that are contained in the alkyl, the better the characteristics of the batteries are at low temperatures. The larger discharging ratio in Embodiment 2 and Embodiment 6 illustrates this effect.

Alkyls are the electron provider group. When carbon atoms increase, the polarity of the compounds that contain the formate derivative or formamide derivative decreases gradually. As a result, the power to form hydrogen bonds between molecules or within the molecules decreases gradually; and the melting point of the compounds increases. At the same time, the dielectric constant of the molecules also decreases. As a result, the properties of the electrolyte formed at low temperatures deteriorate gradually. This may be the reason for the deterioration of the properties of the electrolyte at low temperatures when the number of carbon atoms attached to the alkyl is increased.

A comparison between Embodiment 5 and the other embodiments shows that adding the additive CO₂ can improve the properties of electrolyte at normal temperatures and especially at low temperatures. This is due to the fact that CO₂ can facilitate or accelerate the formation of the passivated-film.

A comparison between Embodiment 1, Embodiment 2 and Embodiment 4 shows that, by appropriately reducing the concentration of electrolyte solute, the properties of the electrolyte at low temperatures can be improved. This increases the discharge ratio without significantly affecting the capacity of the battery at normal temperatures. However, Embodiment 5 shows that too low a concentration of electrolyte will cause a significant decrease in the discharge capacity of a battery at normal temperatures, and, the decrease of the discharge ratio at low/normal temperatures. This effect is primarily caused by the decrease of the conductivity of the electrolyte. Therefore, in order for a battery to have better overall properties, the optimal molar concentration of the electrolyte solute should be between 0.8 mol/l and 1.0 mol/l.

TABLE 1

| | | | Capacity | | |
|---|---|---|---|---|---|
| | | | at | Capacity | |
| | Composition of Solvent; | | Normal | at Low | Discharge |
| | Concentration of Electrolyte | Additive | Temperatures | Temperatures | Ratio |
| | Solute | CO₂ | C_{N} (Ah) | C_{L}(Ah) | K(%) |
| Embodiment 1 | methyl formate:EC:DEC = 5:25:70; | Yes | 12.10 | 6.32 | 52.23 |
| | LiPF₆ = 0.9 mol/l | | | | |
| Embodiment 2 | methyl formate:EC:DEC = 45:15:40; | Yes | 12.50 | 8.50 | 68.00 |
| | LiPF₆ = 0.9 mol/l | | | | |
| Embodiment 3 | methyl formate:isopropyl | Yes | 12.30 | 6.65 | 54.06 |
| | formate:EC:DEC = 60:10:15:15; | | | | |
| | LiPF₆ = 0.9 mol/l | | | | |
| Embodiment 4 | dimethyl formamide:EC:DEC = 30:15:55; | Yes | 12.10 | 7.15 | 59.09 |
| | LiPF₆ = 0.8 mol/l | | | | |
| Embodiment 5 | dimethyl formamide:dipropyl | No | 11.13 | 5.38 | 48.34 |
| | formamide:EC:DEC = 15:5:40:40; | | | | |
| | LiPF₆ = 0.7 mol/l | | | | |
| Embodiment 6 | methyl formate:butyl formate:dipropyl | Yes | 12.28 | 7.90 | 64.33 |
| | formamide:EC:DEC = 10:20:15:15:40; | | | | |
| | LiPF₆ = 0.9 mol/l | | | | |

TABLE 2

| | Composition of | | | | Capacity at | Capacity at | |
|---|---|---|---|---|---|---|---|
| | Solvent (Weight | | | | Normal | Low | Discharge |
| | Ratio) | | | Additive | Temperature | Temperature | Ratio |
| | EC/PC | DEC | DMC | CO₂ | C_{N} (Ah) | C_{L} (Ah) | k (%) |
| Comparison | EC 15 | 15 | 70 | No | 12.44 | 5.30 | 42.60 |
| Example 1 | | | | | | | |
| Comparison | PC 30 | 25 | 45 | No | 11.25 | 4.16 | 36.97 |
| Example 2 | | | | | | | |

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We Claim:

1. An electrolyte comprising:
a lithium salt;
a non-aqueous organic solvent wherein said non-aqueous solvent comprises of at least one compound selected from the group consisting of: a compound having a formate derivative and a compound having a formamide derivative.

2. The electrolyte of claim 1 wherein said compound having a formate derivative is represented by the formula HCOOR₁.

3. The electrolyte of claim 1 wherein said compound having a formamide derivative is represented by the formula HCONR₂R₃.

4. The electrolyte of claim 2 wherein said R₁ is an alkyl.

5. The electrolyte of claim 2 wherein said R₁ is selected from the group consisting of alkyl having 1 to 4 carbons atoms.

6. The electrolyte of claim 3 wherein said R₂ and R₃ are alkyls.

7. The electrolyte of claim 3 wherein said R₂ and R₃ are selected from the group consisting of alkyl having 1 to 4 carbon atoms.

8. The electrolyte of claim 7 wherein said compound having a formate derivative is represented by the formula HCOOR₁ and said R₁ is selected from the group consisting of alkyl having 1 to 4 carbons atoms.

9. The electrolyte of claim 1 wherein said non-aqueous organic solvent comprises of at least one compound selected from the group consisting of: methyl formate, isopropyl formate, butyl formate, dimethyl formamide, dipropyl formamide.

10. The electrolyte of claim 8 wherein said non-aqueous organic solvent comprises of at least one chain acid ester selected from the group consisting of: methyl carbonate, dimethyl carbonate, ethyl carbonate, diethyl carbonate, methyl ethyl carbonate, ethyl propyl carbonate, diphenyl carbonate, ethyl acetate, methyl acetate, methyl propionate, ethyl propionate, dimethoxy ethane, diethoxy ethane, chain organic esters with fluorine, chain acid esters with sulfate, and chain acid esters with unsaturated bond.

11. The electrolyte of claim 8, wherein said non-aqueous organic solvent comprises of at least one ring acid ester selected from the group consisting of: ethylene carbonate, propylene carbonate, vinylene carbonate, γ-butyrolactone, sultone, ring organic esters with fluorine, ring organic esters with sulfate, and ring organic esters with unsaturated bond.

12. The electrolyte of claim 8 wherein the weight of said compound having a formate derivative and said compound having a formamide derivative is between 5 wt % and 70 wt % of the total weight of said non-aqueous organic solvent.

13. The electrolyte of claim 8 wherein said lithium salt is at least one lithium compound selected from the group consisting of: lithium perchlorate, lithium hexaaluminate, lithium hexafluorophosphate, lithium tetrafluoroborate, lithium halide, lithium fluorocarbon fluoro oxide phosphate and lithium fluorocarbon sulfonate.

14. The electrolyte of claim 8 wherein the concentration of said lithium salt in said nonaqueous organic solvent is between 0.8 mol/l and 1.0 mol/l.

15. The electrolyte of claim 8 wherein said electrolyte also comprises of an additive selected from the group consisting of: CO₂, CO, and N₂O and wherein the weight of said additive is between 0.05 wt % and 1.0 wt % of the weight of the electrolyte.

16. The electrolyte of claim 10 wherein said non-aqueous organic solvent comprises of at least one ring acid ester selected from the group consisting of: ethylene carbonate, propylene carbonate, vinylene carbonate, γ-butyrolactone, sultone, ring organic esters with fluorine, ring organic esters with sulfate, and ring organic esters with unsaturated bond.

17. The electrolyte of claim 13 wherein the concentration of said lithium salt in said nonaqueous organic solvent is between 0.8 mol/l and 1.0 mol/l.

18. The electrolyte of claim 16 wherein
said lithium salt is at least one lithium compound selected from the group consisting of: lithium perchlorate, lithium hexaaluminate, lithium hexafluorophosphate, lithium tetrafluoroborate, lithium halide, lithium fluorocarbon fluoro oxide phosphate and lithium fluorocarbon sulfonate;
the concentration of said lithium salt in said nonaqueous organic solvent is between 0.8 mol/l and 1.0 mol/l; and
the weight of said compound having a formate derivative and said compound having a formamide derivative is between 5 wt % and 70 wt % of the total weight of said non-aqueous organic solvent.

19. An electrolyte, comprising:
a lithium salt;
a non-aqueous organic solvent wherein said non-aqueous solvent comprises of at least one compound selected from the group consisting of: compound having a formate represented by the formula HCOOR₁ compound having a formamide derivative represented by the formula HCONR₂R₃; and
an additive selected from the group consisting of: CO₂, CO, and N₂O; and wherein
said R₁ is selected from the group consisting of alkyl having 1 to 4 carbons atoms;
said R₂ and R₃ are selected from the group consisting of alkyl having 1 to 4 carbon atoms;
said non-aqueous organic solvent comprises of at least one chain acid ester selected from the group consisting of: methyl carbonate, dimethyl carbonate, ethyl carbonate, diethyl carbonate, methyl ethyl carbonate, ethyl propyl carbonate, diphenyl carbonate, ethyl acetate, methyl acetate, methyl propionate, ethyl propionate, dimethoxy ethane, diethoxy ethane, chain organic esters with fluorine, chain acid esters with sulfate, and chain acid esters with unsaturated bond;
said non-aqueous organic solvent comprises of at least one ring acid ester selected from the group consisting of: ethylene carbonate, propylene carbonate, vinylene carbonate, γ-butyrolactone, sultone, ring organic esters with fluorine, ring organic esters with sulfate, and ring organic esters with unsaturated bond;
the weight of said compound having a formate derivative and said compound having a formamide derivative is between 5 wt % and 70 wt % of the total weight of said non-aqueous organic solvent;
said lithium salt is at least one lithium compound selected from the group consisting of: lithium perchlorate, lithium hexaaluminate, lithium hexafluorophosphate, lithium tetrafluoroborate, lithium halide, lithium fluorocarbon fluoro oxide phosphate and lithium fluorocarbon sulfonate;
the concentration of said lithium salt in said nonaqueous organic solvent is between 0.8 mol/l and 1.0 mol/l; and
the weight of said additive is between 0.05 wt % and 1 .Owt % of the weight of the electrolyte.

20. A lithium ion battery, comprising:
a positive electrode;
a negative electrode,
a separation membrane, and
an electrolyte wherein
said electrolyte comprises of a lithium salt; a non-aqueous organic solvent comprises of at least one compound selected from the group consisting of: compound having a formate represented by the formula HCOOR₁ compound having a formamide derivative represented by the formula HCONR₂R₃; and an additive selected from the group consisting of: CO₂, CO, and N₂O;
said R₁ is selected from the group consisting of alkyl having 1 to 4 carbons atoms;
said R₂ and R₃ are selected from the group consisting of alkyl having 1 to 4 carbon atoms;
said non-aqueous organic solvent comprises of at least one chain acid ester selected from the group consisting of: methyl carbonate, dimethyl carbonate, ethyl carbonate, diethyl carbonate, methyl ethyl carbonate, ethyl propyl carbonate, diphenyl carbonate, ethyl acetate, methyl acetate, methyl propionate, ethyl propionate, dimethoxy ethane, diethoxy ethane, chain organic esters with fluorine, chain acid esters with sulfate, and chain acid esters with unsaturated bond;
said non-aqueous organic solvent comprises of at least one ring acid ester selected from the group consisting of: ethylene carbonate, propylene carbonate, vinylene carbonate, γ-butyrolactone, sultone, ring organic esters with fluorine, ring organic esters with sulfate, and ring organic esters with unsaturated bond;
the weight of said compound having a formate derivative and said compound having a formamide derivative is between 5 wt % and 70 wt % of the total weight of said non-aqueous organic solvent;
said lithium salt is at least one lithium compound selected from the group consisting of: lithium perchlorate, lithium hexaaluminate, lithium hexafluorophosphate, lithium tetrafluoroborate, lithium halide, lithium fluorocarbon fluoro oxide phosphate and lithium fluorocarbon sulfonate;
the concentration of said lithium salt in said nonaqueous organic solvent is between 0.8 mol/l and 1.0 mol/l; and
the weight of said additive is between 0.05 wt % and 1.0 wt % of the weight of the electrolyte.
